(19) United States
(12) Patent Application Publication
(10) Pub. No.: US 2003/0072402 A1
(43) Pub. Date: Apr. 17, 2003

(54) Gold, platinum, palladium, silver and all precious metals and precious elements made from other elements by splitting

(76) Inventor: Hanna Albert Awad, Ajaltoun (LB)

Correspondence Address: Hanna Albert Awad, 4721 Nathan West, Sterling Heights, MI, 48310, US

(21) Appl. No.: 09/973,831

(22) Filed: Oct. 11, 2001

(51) Int. Cl. G21G 1/00

(52) U.S. Cl. 376/156

(57) ABSTRACT

Gold, silver, platinum, palladium and all precious metals and elements can be made from other elements. By taking the element which has double the atomic number of the precious element (ex: gold) and bombarding its nucleus with neutrons and protons. This element which has double the atomic number will split into the precious element (gold) and will have a chain reaction and turn the hole material into gold (a concentration of 80% gold). By experimentation, we find which of the elements which has (double the atomic number or double the atomic number +1, or double the atomic number +2 or −1) will give the most concentration of gold after splitting. We will take the less expensive element, and the one who will give the most concentration between the elements that has double the atomic number +1, or −1, or +2.

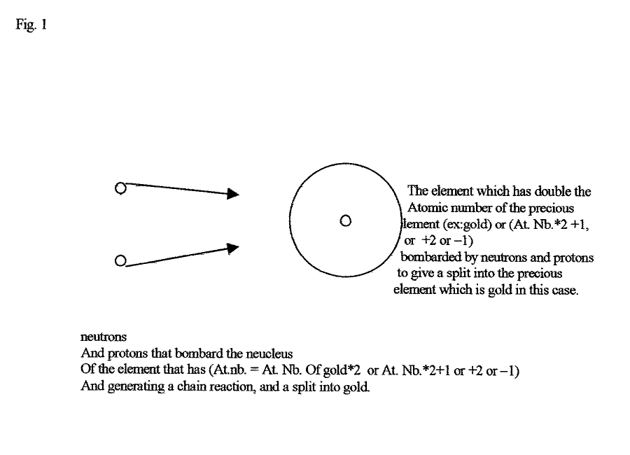

### 2—CIRCUMSTANCES AND DATE OF CONCEPTION

In 1975—It goes back to school in Lebanon, where we learned that the arabs had a science called alchemistry, constituting of making gold from other materials. Of course it did not work. In 1998, I was talking about what we learning at school and remembered and figured out what if we can make gold from other elements by adding a proton and a neutron to an element that have double the number of neutrons of gold. It will result in a chain reaction and the splitting of that element into gold and other elements. Three or more consecutive elements could give gold by splitting. By experiment we could figure out what is the cheapest element that gives the most dense gold by splitting. This applies to all precious metals and precious elements (gold, platinum, palladium, silver etc. . . . )

### 3—DESCRIPTION OF THE ICON

If you add neutrons and protons to the nucleus of the atom of plutonium (which is made from uranium), you get a chain reaction and an atomic bomb.

If you bombard or add neutrons and protons to any element you will have a chain reaction.

The chain reaction of any element (in the element table) is the split of the nucleus into other elements and a free jet of neutrons and protons to generate other bombardments of nucleuses of other atoms (which is the chain reaction).

If you bombard the element that have double the number of protons and neutrons of gold (or one of the three consecutive elements (after the double of the number of the neutrons of gold)), you will get a split of that element into gold and other elements and a chain reaction.

By experiment, you get to the element that splits and gives the largest amount of gold atoms by splitting (and which is the cheapest).

By doing so, you can get gold, platinum, palladium, silver and other precious metals and precious elements.

A manufacturing plant would take place of mines and digging deep in the ground. An unlimited resource is generated.

PURPOSE: An unlimited resource is generated. A small manufacturing plant without risks will take place of mines and digging deep into the ground. Cutting costs, more secure work, availability to everybody and unlimited resource. Rare elements could be generated that could be used in manufacturing, space, high tech. etc. . . .

PARTS: a nuclear power generation plant will have the sane parts and the same constitutional system. That would generate precious element. We just have to put the desired element instead of plutonium and we get the desired precious element.

USE: we just have to put the desired element instead of plutonium in a nuclear power generation plant and we get the desired precious element. The generation of chain reaction should be done ounce and gold or other desired element is generated.

NOVEL FEATURES: mines are still used until now and a constant price is kept for all precious metals, which proves that my invention is new and it has no similar until now.

ADVANTAGES: an unlimited resource, better prices, non dangerous work, availability to everybody and clean and respectable work to generate precious elements. A small plant (one eight of the size of a nuclear power generation plant could take place of hole mines of gold in a rich gold country.

4—TESTING RESULTS: if an atomic bomb works, and a nuclear power generation plant works, this invention must work. It has the same principle of an atomic bomb and a nuclear power generation plant. It is an application of the theory of chain reactions.

I claim:

1. the right for the production and trade of all precious metals and precious Elements made from other elements.
